(19) United States
(12) Patent Application Publication
(10) Pub. No.: US 2020/0007628 A1
(43) Pub. Date: Jan. 2, 2020

(54) METHOD AND APPARATUS FOR ESTABLISHING A CONNECTION WITH A CONTENT SERVER

(71) Applicant: Samsung Electronics Co., Ltd., Suwon-si (KR)

(72) Inventors: Karthikeyan ARUNACHALAM, Bangalore (IN); Jamsheed Manja PPALLAN, Bangalore (IN); Dronamraju Siva SABAREESH, Bangalore (IN); Sweta JAISWAL, Bangalore (IN); Madhan Raj KANAGARATHINAM, Bangalore (IN); Kyoungjin MOON, Suwon-si (KR)

(21) Appl. No.: 16/426,454

(22) Filed: May 30, 2019

(30) Foreign Application Priority Data
May 30, 2018 (IN) 201841020197
May 22, 2019 (IN) 2018 41020197

(51) Int. Cl. H04L 29/08; H04L 12/26; H04L 29/12

(52) U.S. Cl. CPC H04L 67/141; H04L 43/0864; H04L 67/10; H04L 67/18; H04L 61/1511

(57) ABSTRACT

A method and a user terminal for establishing a connection between the user terminal and a content server are provided. The method includes receiving, at the user terminal, a domain name server (DNS) response including addresses of a plurality of content delivery network (CDN) servers, detecting a round trip time (RTT) for each of the plurality of the CDN servers based on the address of each of the plurality of the CDN servers, the RTT being a time length for rounding trip from the user terminal via one of the CDN servers to the user terminal, determining a first CDN server based on the lowest RTT, transmitting a request for content to the first CDN server, and receiving the requested content from the first CDN server.

### CROSS-REFERENCE TO RELATED APPLICATION(S)

This application is based on and claims priority under 35 U.S.C. § 119 of an Indian patent application number 201841020197, filed on May 30, 2018, in the Indian Patent Office, and of an Indian patent application number 201841020197, filed on May 22, 2019, in the Indian Patent Office, the disclosure of each of which is incorporated by reference herein in its entirety.

### BACKGROUND

### 1. Field

The disclosure relates to establishing a connection between a user terminal and a content server. More particularly, the disclosure relates to a transport path explorer (TransPlorer) method and user equipment (UE) for determining an optimal content server and an optimal network path by exploring network paths between the UE and content servers in a wireless network system.

### 2. Description of Related Art

A primary goal of a next generation network (NGN) is to increase a network capacity and provide higher data rates, ultra reliable low latency communications (URLLC) and an improved quality of service (QoS). A fifth generation (5G) new radio (NR) network is opted for millimeter wave (mmWave) spectrum which increases the network capacity for the NGN. In the current cellular networks, the network capacity changes drastically when an antenna link between a user equipment (UE) (100) and a base station changes from a line-of-sight (LOS) path to a non-line-of-sight (NLOS) path. The changes in the antennae link result in a serious performance degradation in a transmission control protocol (TCP) connection due to packet drops and increased round trip time (RTT). A quality of a network path varies based on a type of network, a type of network interface (e.g. Wi-Fi network interface, Cellular network interface), a user mobility, a signal strength and a congestion in the network path. Therefore, multiple network architecture options are available in the 5G NR network for overcoming the performance degradation in the TCP connection, due to a lower network path quality.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method of providing an intelligent response on an electronic device.

Additional aspects will be set forth in part in the description which follows and, in part, will be apparent from the description, or may be learned by practice of the presented embodiments.

In accordance with an aspect of the disclosure, a method for establishing a connection between the user terminal and a content server is provided. The method includes receiving, at the user terminal, a domain name server (DNS) response including addresses of a plurality of content delivery network (CDN) servers, detecting a round trip time (RTT) for each of the plurality of the CDN servers based on the address of each of the plurality of the CDN servers, the RTT being a time length for rounding trip from the user terminal via one of the CDN servers to the user terminal, determining a first CDN server based on the lowest RTT, transmitting a request for content to the first CDN server, and receiving the requested content from the first CDN server.

In an embodiment, the method further comprises transmitting, to a DNS, a request for the addresses of the plurality of the CDN servers, wherein the DNS response is received in response to the request for the addresses of the plurality of the CDN servers.

In an embodiment, the method further includes selecting the DNS for the request of the addresses of the plurality of the CDN servers, based on location information of the user terminal.

In an embodiment, the method further includes storing the addresses of the plurality of CDN servers in a first content cache of the user terminal.

In an embodiment, the method further includes establishing a connection to the first CDN server to transmit the request for the content, wherein the connection is established by connecting to the first CDN server with a socket descriptor of the user terminal.

In an embodiment, the method further includes determining path characteristics for each network path between the user terminal and each of the plurality of the CDN servers, wherein the path characteristics comprise at least one of a behavior of applications installed in the user terminal, the number of connections per domain, or the number of application request forwarded to each of the plurality of the CDN servers.

In an embodiment, the transmitting of the request for the content to the first CDN server includes routing the request for the content to the first CDN server by mapping a socket descriptor of an application requesting the content to a socket descriptor of the first CDN server.

In an embodiment, the method further includes monitoring a network path quality between the user terminal and the first CDN server, determining whether the network path quality meets a predetermined value, and switching a connection to a second CDN server based on the network path quality.

In an embodiment, the determining of whether the network path quality meets the predetermined value includes determining the network path quality based on at least one of a user mobility, a signal strength fluctuation, a signal to noise ratio, a degree of a congestion in a path of a network, a type of network interface, packet processing time, or a type of IP which includes IPv4 or IPv6.

In an embodiment, the type of network interface includes at least one of Wi-Fi network interface or a cellular network interface.

In an embodiment, the detecting of the RTT for each of the plurality of the CDN servers includes identifying the RTT for each of the plurality of the CDN servers based on at least one of a behavior of application installed in the user terminal, the number of connections per domain, the number of application request forwarded to each of the CDN servers, or a network path quality.

In accordance with another aspect of the disclosure, an apparatus for establishing a connection with a content server is provided. The apparatus includes a memory, and at least one processor configured to receive a domain name server (DNS) response including addresses of a plurality of content delivery network (CDN) servers, detect a round trip time (RTT) for each of the plurality of the CDN servers based on the address of each of the plurality of the CDN servers, the RTT being a time length for rounding trip from the apparatus via one of the CDN servers to the apparatus, determine a first CDN server based on the lowest RTT, transmit a request for content to the first CDN server, and receive the requested content from the first CDN server.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating a wireless network system for providing content to a user equipment (UE) according to an embodiment of the disclosure;

FIG. 2 is a block diagram of a UE for routing a request for content to a content server, according to an embodiment of the disclosure;

FIG. 3 is a schematic diagram illustrating a wireless network system for providing the content to the UE from the content server, according to an embodiment of the disclosure;

FIG. 4A is a flowchart for establishing a connection between a user terminal and a content server, according to an embodiment of the disclosure;

FIG. 4B is a flowchart illustrating a method for establishing a connection between a user terminal and the content server, according to an embodiment of the disclosure;

FIG. 4C is a flowchart illustrating a method of switching the connection, according to an embodiment of the disclosure;

FIG. 5 illustrates an example scenario in which the UE receives domain name server (DNS) messages from a DNS server, according to an embodiment of the disclosure;

FIG. 6 illustrates an example scenario in which the UE receives the DNS messages from DNS servers, according to an embodiment of the disclosure;

FIG. 7 illustrates an example scenario in which the UE determines the optimal network path for a network interface for accessing content, according to an embodiment of the disclosure;

FIG. 8 illustrates an example scenario in which the UE switches seamlessly from a connection to a content server to a connection to another content server using a socket descriptor, according to an embodiment of the disclosure; and

FIG. 9 is a schematic diagram illustrating an experimental setup for evaluating the TransPlorer method, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the terms “1st” or “first” and “2nd” or “second” may use corresponding components regardless of importance or order and are used to distinguish one component from another without limiting the components.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

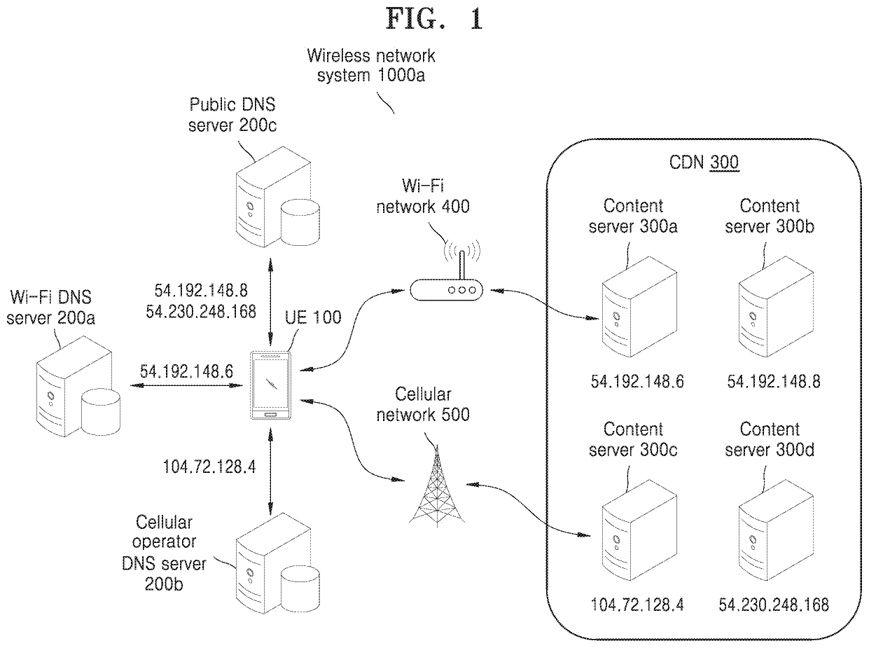

Referring now to the drawings, and more particularly to FIGS. 1 through 9, where similar reference characters denote corresponding features consistently throughout the figures, there are shown embodiments.

FIG. 1 illustrates a wireless network system (1000a) for providing the content to the user equipment (UE) (100) from a content server according to an embodiment of the disclosure.

Among all the multiple network architecture options, a non-stand alone (NSA) architecture, i.e., option-3 and a stand alone (SA) architecture, i.e., option-2 are selected for an initial deployment of the fifth generation (5G) new radio (NR) network. The NSA architecture of the 5G NR network provides a dual connectivity (DC) feature to the UE (100) by allowing the UE 100 to connect both a fourth generation long term evolution (4G-LTE) network and the 5G NR network simultaneously. The DC allows the UE 100 to seamlessly connect from a 4G-LTE cell to a 5G NR cell, when the location of the UE 100 is changed.

The 5G NR network is a heterogeneous network comprising multiple radio resources to fulfil a requirement of the higher data rates and an ultra-low latency. multi-connectivity (MC) feature is another emerging technology for the 5G NR network, where the MC feature enables the UE (100) to aggregate multiple radio resources from different radio access technologies (RATs) such as a Wi-Fi network 400, the 4G-LTE network and the 5G NR network. Further, the MC feature enables the UE 100 to connect simultaneously to different RATs. The UE 100 is equipped with multiple network interfaces (e.g. Wi-Fi network interface, cellular network interface) and support dual stack networks (i.e. IPv4/IPv6). Even though the UE 100 supports connecting simultaneously to the different RATs, a client application in the UE application is not aware of an optimal interface and an optimal network path for connecting to a content server for accessing content (e.g. video, image, audio, text, animations etc.). Selecting the network path having poor quality leads the UE 100 to initiate a handover from a micro cell to a macro cell, which causes the performance degradation in the transmission control protocol (TCP) connection. Further, the poor quality of the network path leads to increase a socket set-up time, retransmit packets and increase RTT of the TCP connection.

A content distribution network (CDN) 300 is a geographically distributed network for a plurality of content servers 300a-300d in different geographical locations. The CDN 300 provides infrastructure to distribute the content redundantly across the multiple content servers 300a-300d in the different geographical locations. The RTT of each of the content server 300a-300d differs in downloading the content by the UE 100. The RTT of each of the content server 300a-300d depends on the quality of the network path and a load on the content server 300a-300d when the content is provided to the UE 100. The poor quality of the network path makes the connection quality worse with time required to download the content by the UE 100.

The application in the UE 100 is only aware of a list of content servers provided by a domain name system (DNS) server. The list of content servers includes address of all the content servers 300a-300d. The address may be an IP address. The UE 100 connects to the CDN 300 either through a Wi-Fi network 400 or through a cellular network 500. The CDN 300 includes content servers 300a, 300b, 300c and 300d. The UE 100 may connect to a Wi-Fi DNS server 200a, a cellular operator DNS server 200b and a public DNS server 200c. The Wi-Fi DNS server 200a provides the IP address of the content server 300a to the UE 100. Therefore, the content server 300a can be the default content server for the UE 100 to download the content form the CDN 300, when the UE 100 requests to the CDN 300 for fetching the content through the Wi-Fi network interface.

The cellular operator DNS server 200b provides the IP address of the content server 300c to the UE 100. Therefore, the content server 300c is the default content server for the UE 100 to provide the content from the CDN 300, when the UE 100 requests to the CDN 300 for fetching content through the cellular network interface. The public DNS server 200c provides a list of the content servers 300b and 300d, for example, to the UE 100. The RTT of the content server 300a-300d varies due to a latency of the network interface, the quality of the network path and processing time of the content server 300a-300d or middle boxes. Therefore, the default content server may not be able to maintain the lowest RTT all the time, whereas the RTT of the content server 300b may be the lowest at the same time for the UE 100 to download the content from the content server 300b in a short time with respect to the time required to download the content from the default content server. Therefore, the content server 300b is an optimal content server for the UE 100 to perform the data communication. However, the UE (100) has no choice but to choose only the IP address of the default content server for downloading the content and discard the rest of the IP address of other content servers.

Mobile edge computing (MEC) adopts, in the 5G NR network, to deploy edge content servers located close to the UE 100. The RTT of the edge servers are lesser compared to remote content servers. Moreover, the edge content servers quickly adapt to impairments in the network path of the cellular network and significantly improve a performance of the transmission control protocol (TCP) connection, compared to the remote content servers. However, the client application may not be aware of the edge content servers, even though the edge content servers are located close to the UE 100.

When a system uses the network path diversity and establishes the TCP connection simultaneously with multiple content servers to fetch the content, the system is limited to download the content based only on HTTP protocol. In another system, the network path diversity is used between the UE 100 and the content server 300a. However, a kernel level modification is required at both of a UE end and a content server end to use the network path diversity. Further, a modification of the middle boxes is required to use the network path diversity, which is more complicated to deploy the system. Another system selects an appropriate access network and achieves reliable low-latency data transmission. However, the kernel level modification and the modification of the middle boxes are necessary for the deployment of the system, which is more complicated to deploy the system. Another system allows the CDN 300 to learn that the UE 100 has multiple network interfaces. Further, the system provides an end-to-multi end solution that improves content delivery in the CDN 300.

A DNS proxy is used by another system to determine a TCP connection establishment time for selecting the optimal content server. However, the system does not reuse the TCP connection used in probing for the optimal content server. Therefore, the system wastes the connection resources. Another system selects the optimal content server for downloading the content replicated over multiple content servers. However, the system does not use the network path diversity arising from the multiple network interfaces available at the UE 100. The systems may improve the selection of the content server, to dynamically determine the optimal content server at a moment.

Accordingly, the embodiments herein provide a TransPlorer method for determining an optimal content server in a wireless network system. The method includes storing, by a UE, a list of address identifiers of content servers in the wireless network system. Further, the method includes establishing, by the UE, a connection with each of the content servers based on the list of address identifiers of the content servers through network paths available at network interfaces of the UE. Further, the method includes receiving, by the UE, a content request from at least one application of the UE. Further, the method includes determining, by the UE, the optimal content server from the content servers and an optimal network path from the network paths available at the network interfaces based on an RTT of each connection. Further, the method includes routing, by the UE, the content request to the optimal content server through the optimal network path to perform a data communication.

The TransPlorer method can be used, by the UE, to explore the content servers available in a CDN and identify the optimal content server in the content servers. Further, the TransPlorer method can be used in the UE to determine a network path optimal for the UE to communicate with the optimal content server based on a quality of the network path. Therefore, the UE can download the content faster from the CDN by receiving the data from the optimal content server without modifying applications in the UE, existing network protocols, a kernel and middle boxes.

The UE utilizes both a path diversity and a content source diversity to determine the optimal network path at each moment of time. The TransPlorer method allows the UE to migrate a TCP connection seamlessly between available network interfaces (e.g. cellular network interface, Wi-Fi network interface etc.) without affecting a user experience, in response to determining the optimal network path.

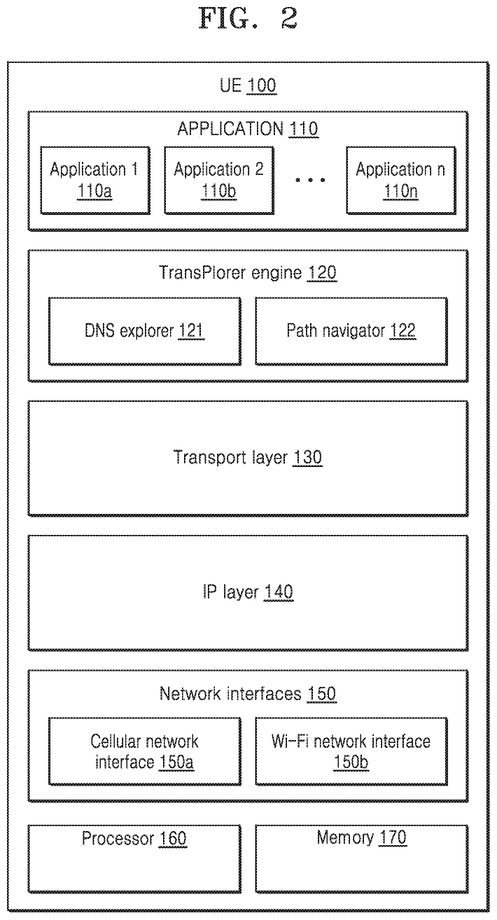

FIG. 2 is a block diagram of a UE for routing a request for content to a content server, according to an embodiment of the disclosure.

Referring to FIG. 2, the UE 100 may include a TransPlorer engine 120 for routing the request to an optimal content server through an optimal network path. The UE 100 may be, but not limited to, a smart phone, a tablet computer, a personal computer, a desktop computer, a personal digital assistance (PDA), a wearable device, and the like.

In an embodiment, the UE 100 includes a plurality of applications 110a, 110b, . . . , 110n, a TransPlorer engine 120, a transport layer 130, an IP layer 140, network interfaces 150, a processor 160 and a memory 170. The TCP/IP layer may be formed by combining the transport layer 130 and the IP layer 140.

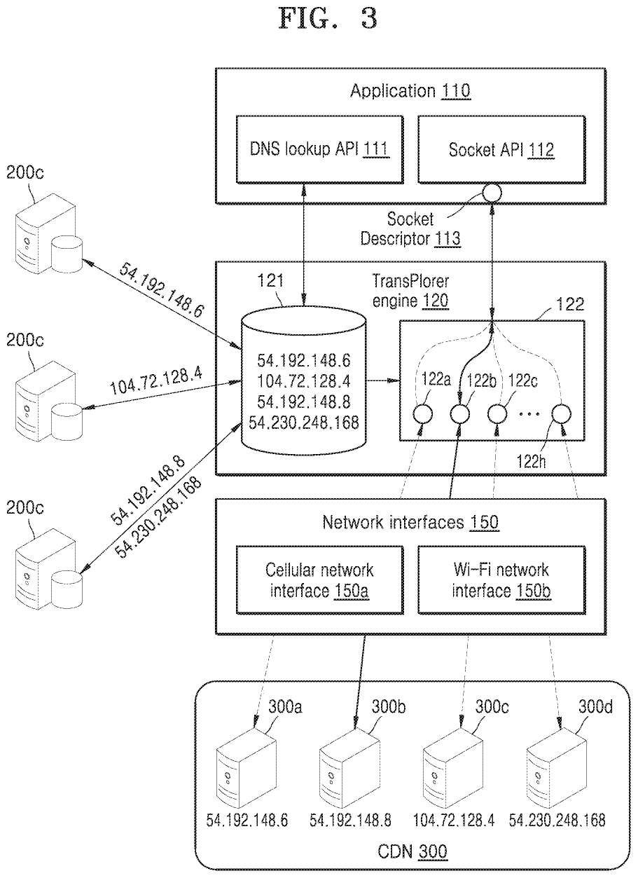

FIG. 3 is a schematic diagram illustrating a wireless network system for providing the content to the UE from the content server, according to an embodiment of the disclosure.

Referring to FIG. 3, the application 110 may include a DNS lookup application programming interface (API) 111, a socket API 112, and a socket descriptor 113.

In an embodiment, the TransPlorer engine 120 may include a DNS explorer 121 and a path navigator 122. The path navigator 122 may include a plurality of socket descriptor 122a-122d referring to FIG. 3. The TransPlorer engine 120 is coupled to the processor 160 and the memory 170. The TransPlorer engine 120 may be configured to receive DNS messages (also called as DNS responses) over a period of time (e.g., 1 millisecond) from at least one DNS server in a wireless network system. A DNS message includes address identifiers (e.g., IP address) of at least one content server in the wireless network system.

In an embodiment, the TransPlorer engine 120 may be configured to generate a DNS query based on location information of the UE 100, network operators, a network backhaul connected behind and/or root servers in network path. Further, the TransPlorer engine 120 may be configured to transmit the DNS query to the at least one DNS server 200a-200c for obtaining the DNS messages from the at least one DNS server 200a-200c. The TransPlorer engine 120 may be configured to receives the DNS messages over the period of time from the at least one DNS server 200a-200c in the wireless network system. The TransPlorer engine 120 may be configured to store the address identifiers in the form of a list in the memory 170.

In an embodiment, the DNS explorer 121 generates a query (a DNS query). Further, the DNS explorer 121 transmits the DNS query to the at least one DNS server 200a-200c and the DNS explorer 121 receives the DNS messages over a period of time from the at least one DNS server 200a-200c. The memory 170 stores the addresses or the address identifiers in the form of a list. In another embodiment, the TransPlorer engine 120 is configured to store the address identifiers or the addresses in a cache of the memory 170. The cache may be a DNS cache. The DNS explorer 121 may analyze each of the DNS responses and categorize the type of a network stack into IPv4 or IPv6. The DNS explorer 121 renews the DNS cache and deletes a rarely used or unused domain names (i.e. IP address) from the DNS cache periodically. The DNS explorer 121 optimizes the DNS query and reduces a number of DNS query outgoing from the UE 100. The TransPlorer engine 120 may identify the at least one content server 300a-300d with at least one network interface 150.

The TransPlorer engine 120 may establish a connection with each of the content servers 300a-300d based on the list of address identifiers of the content servers 300a-300d. In an embodiment, the TransPlorer engine 120 may establish the connection simultaneously or in consecutive order with each of the content servers 300a-300d based on the list of address identifiers of the content servers 300a-300d. In an embodiment, the connection is a TCP connection. In an embodiment, the path navigator 122 establishes the connection with each of the content servers 300a-300d based on the list of address identifiers of the content servers 300a-300d. In another embodiment, the path navigator 122 establishes the connection with each of the content servers 300a-300d by connecting to the content servers 300a-300d with the plurality of socket descriptor 122a-122d based on the list of address identifiers of the content servers 300a-300d. In another embodiment, the TransPlorer engine 120 may establish the connection using each of the socket descriptors (122a-122h) to each of the content servers (300a-300d) through the network interfaces 150. In an embodiment, the path navigator 122 establishes the connection using each of the socket descriptors 122a-122h to each of the content servers 300a-300d through the network interfaces 150.

Further, the TransPlorer engine 120 is configured to receive a content request from the application 110. In an embodiment, the DNS lookup API 111 generates the content request and sends the content request to the DNS explorer 121, when the application 110 need to receive a content from CDN 300. The DNS explorer 121 provides the content request and the address identifiers to the path navigator 122, in response to receiving content request from the application 110.

The TransPlorer engine 120 may determine the optimal content server 300b from the content servers 300a-300d and the optimal network path from network paths available at the network interfaces 150 based on an RTT of each connection. In an embodiment, the TransPlorer engine 120 may determine at least one of a behavior of the application 110, a number of connections per domain, a number of application request (i.e. the content request) forwarded through each of the connection of the content servers 300a-300d and a network path quality.

In an embodiment, the TransPlorer engine 120 may determine the network path quality based on at least one of a user mobility, a signal strength fluctuation, a signal to noise ratio, a degree of a congestion in the network path, a type of network interface 150, packet processing time and a type of IP (e.g. IPv4, IPv6). Examples for the network interface are a cellular network interface 150a, a Wi-Fi network interface 150b, and the like. Examples for the cellular network interface are a second generation (2G) cellular network interface, a third generation (3G) cellular network interface, a 4G-LTE cellular network interface, fifth generation new radio (5G NR) cellular network interface and the like. Further, the TransPlorer engine (120) may detecting or identifying the RTT of each of the connection of the content servers 300a-300d based on at least one of the behavior of the application 110, the number of connections per domain, the number of application request forwarded through each of the connection of the content servers 300a-300) and the network path quality. Further, the TransPlorer engine 120 may determine the optimal content server 300b from the content servers 300a-300d and the optimal network path from the network paths available at the network interfaces 150 based on the RTT of each of the connection of the content servers 300a-300d.

In an embodiment, the path navigator 122 determines at least one of the behavior of the application 110, the number of connections per domain, the number of application request forwarded through each of the connection of the content servers 300a-300d and the network path quality. Further, the path navigator 122 identifies the RTT of each of the connection of the content servers 300a-300d based on at least one of the behavior of the application 110, the number of connections per domain, the number of application request forwarded through each of the connection of the content servers 300a-300d and the network path quality. Further, the path navigator 122 dynamically determines the optimal content server 300b from the content servers 300a-300d and the optimal network path from the network paths available at the network interfaces 150.

TransPlorer engine 120 may determine path characteristics for each network paths corresponds to the connection over the period of time. In an embodiment, the path characteristics includes at least one of the behavior of the application 110, the number of connections per domain, and the number of application request forwarded to or through each of the connection to the content servers 300a-300d. In an embodiment, the path navigator 122 determines the path characteristics for each network path corresponds to the connection over the period of time.

The TransPlorer engine 120 may route or transmit the content request to the optimal content server 300b through the optimal network path for accessing the content from the optimal content server 300b. In an embodiment, the content request is routed or transmitted through the optimal network path to the optimal content server 300b by mapping the socket descriptor 113 of the application 110 requesting the content to the socket descriptor (22b of the optimal content server 300b transparently.

In an embodiment, the path navigator (122) routes the content request to the optimal content server 300b through the optimal network path for accessing the data of the content from the optimal content server 300b. In an embodiment, the path navigator 122 maps the socket descriptor 122a-122e that connected to the application 110 directly for the HTTP session. In case of the HTTPS session, the path navigator 122 taps SSL libraries (e.g., openSSL, boringSSL). Further, the path navigator 122 maps socket descriptor 122a-122e along with SSL parameters such as a cipher suite, private/public keys, and certificates to the application 110. Therefore, the path navigator 122 establishes a HTTPS connection over the multiple network interfaces 150 and dynamically maps the SSL session along with socket descriptor 122a-122e to the application 110, when the application 110 requests for a secure connection. Thus, the UE 100 handles the SSL sessions and supports the HTTPS connection.

In another embodiment, the TransPlorer engine 120 is configured to map the socket descriptor 113 of the application 110 with at least one of the socket descriptor 122a-122h each of which corresponds to each CDN servers 300a-300d. In an embodiment, the path navigator 122 maps the socket descriptor 113 of the application 110 with at least one of the socket descriptor 122a-122h.

The TransPlorer engine 120 may determine whether a signal strength associated with the connection corresponding to the optimal content server 300b meets a signal strength criteria. In an embodiment, the optimal content server 300b meets the signal strength criteria, when the RTT of connection of the content server 300d is lower than the RTT of connection of the optimal content server 300b. In an embodiment, the path navigator 122 determines whether the signal strength associated with the connection corresponding to the optimal content server 300b meets the signal strength criteria. The TransPlorer engine 120 is configured to determine the content server 300d from the plurality of content servers 300a-300d, optimal for accessing the data of the content, when the signal strength associated with the connection corresponding to the optimal content server 300b meets the signal strength criteria. The content server 300d is optimal to perform the data communication with the UE 100, when the signal strength associated with the connection corresponding to the optimal content server 300b meets the signal strength criteria.

In an embodiment, the path navigator 122 determines the content server 300d from the plurality of content servers, optimal for accessing the data of the content, when the signal strength associated with the connection corresponding to the optimal content server 300b meets the signal strength criteria. The TransPlorer engine 120 is configured to route the content request through the connection corresponding to the content server 300d by seamlessly switching from the connection corresponding to the optimal content server 300a to the connection corresponding to the content server 300d. In an embodiment, the connection corresponding to the content server 300d is the optimal network path of the UE 100, when the signal strength associated with the connection corresponding to the optimal content server (300b) meets the signal strength criteria.

In another embodiment, the TransPlorer engine 120 is configured to monitor a network path quality of each of the network interfaces 150 and the network paths. In an embodiment, the network path quality is monitored by determining the network path quality based on the at least one of the user mobility, the signal strength fluctuation, the signal to noise ratio, the congestion in the network path, the type of network interface 150, the packet processing time and the type of Internet Protocol (IP) network stack. In an embodiment, the path navigator 122 monitors the network path quality of each of the network interfaces 150 and the network paths. The TransPlorer engine 120 may generate a trigger in response to determining that the network path quality does not meet a threshold network path quality. In an embodiment, the path navigator 122 generates the trigger in response to determining that the network path quality does not meet a threshold network path quality. The TransPlorer engine 120 may switch the connection in between the plurality of interfaces 150 based on the trigger. In an embodiment, the path navigator 122 switches the connection in between the plurality of interfaces 150 based on the trigger.

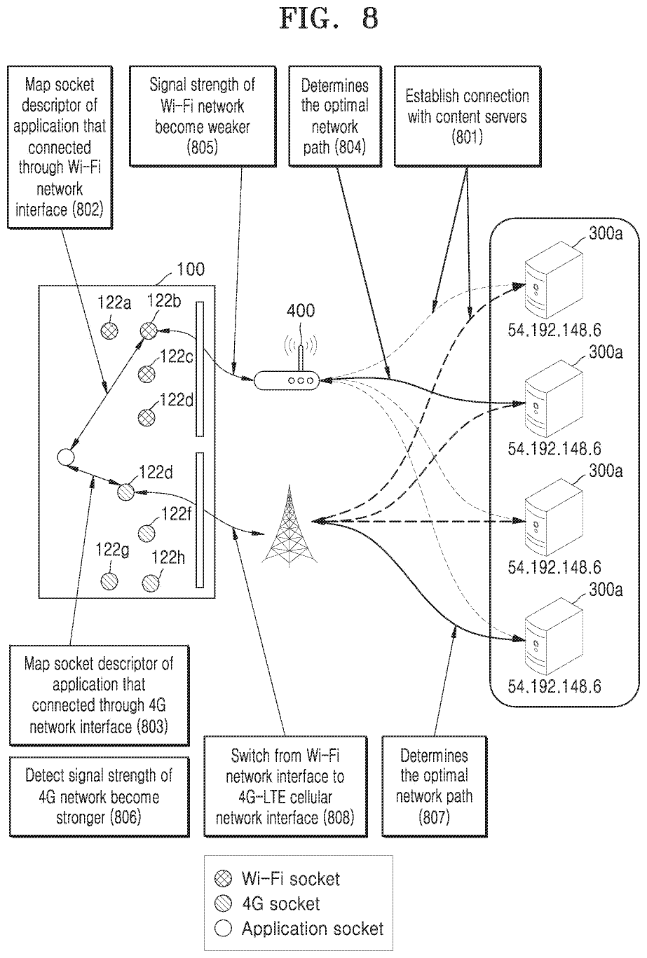

In an embodiment, seamlessly switching from the connection corresponding to the optimal content server 300b to the connection corresponding to the content server 300d is performed by mapping the socket descriptor 113 of the application to the socket descriptor 122e (shown in FIG. 8) of the content server 300d transparently. In an embodiment, the connection corresponding to the content server 300d is established using a second network interface. In an example, the second network interface is the Wi-Fi network interface 150a. In an embodiment, the path navigator 122 routes the content request through the connection corresponding to the content server 300d by seamlessly switching from the connection corresponding to the optimal content server 300a to the connection corresponding to the content server 300d.

In an embodiment, the path navigator 122 takes input from the DNS cache and identifies the list of the content servers 300a-300d available for a domain name by considering both the network stacks IPv4 and IPv6. Further, the path navigator 122 establishes the connections to the mirror servers using multiple network interfaces (e.g. Wi-Fi network interface, 4G-LTE cellular network interface, 5G NR network interfaces etc.). Further, the path navigator 122 monitors the RTT of these TCP connections and dynamically determines the network path, the network interfaces 150 and content servers (300a-300d) available at a first moment, optimal to perform the data communication. When the application 110 tries to establish a new TCP connection or sends a data request. Further, the path navigator 122 migrates the connection to the TCP connection which is optimal. Therefore, the method improves a content downloading or page loading time of the UE 100 without degrading a performance of the UE 100.

In an embodiment, the TransPlorer engine 120 keeps the TCP connection having a lowest RTT alive and ignores other TCP connections, after establishing the connections with multiple content servers 300a-300d. The TCP connection which is kept idle for long time will be closed by the content server 300a-300d. Based on a data flow and a server timeout of the TCP connection, the TransPlorer engine 120 classifies the TCP connection as a short lived or a long lived connection. For, the long lived connection, the TransPlorer engine 120 sends probe packets periodically to the content server 300a-300d and keeps the connection alive from the server timeout.

In case of the short lived connections, creating multiple TCP connections will waste resources in both the UE 100 and the content server 300a-300d, where the short lived connections might get closed before mapping. Therefore, the TransPlorer engine 120 creates optimal number of the short lived connections and utilize all of the short lived connections by analyzing a connection pattern of the application 110, maintaining a connection history and the server timeout. Thus, the TransPlorer engine 120 effectively handles the TCP connections and minimizes the waste of socket resources. When the UE 100 is in idle mode, the UE 100 periodically sends the data over the TCP connection, which wakes up radio resources of a modem and consumes power significantly. The TransPlorer engine 120 combines its socket resources creation with at least one of the application request. Thus, the TransPlorer engine 120 avoids extra radio wake ups in the modem and the wastage of the power.

The transport layer 130 enables a logical and error-free end-to-end communication of data between the UE 100 and the content servers 300a-300d or the DNS servers 200a-200c. The transport layer 130 uses a network communication protocol for logical and error-free end-to-end communication of the data. The IP layer 140 is configured to communicate the data in the form of packets to/from the content servers 300a-300d or the DNS servers 200a-200c based on the address identifiers. The network interfaces 150 enables the UE 100 to physically communicate the data to/from the content servers 300a-300d or the DNS servers 200a-200c. The network interfaces 150 includes the first network interface 150a (e.g. cellular network interface) and the second network interface 150b (e.g. Wi-Fi network interface). The network interfaces 150 configured to pre-connect the UE (100) to all of the content servers 300a-300d using the network communication protocol based on the address identifiers.

The processor 160 is configured to execute instructions stored in the memory 170. The memory 170 may include non-volatile storage elements. Examples of such non-volatile storage elements may include magnetic hard discs, optical discs, floppy discs, flash memories, or forms of an electrically programmable memory (EPROM) or an electrically erasable and programmable memory (EEPROM).

In addition, the memory 170 may, in some examples, be considered a non-transitory storage medium. The term “non-transitory” may indicate that the storage medium is not embodied in a carrier wave or a propagated signal. However, the term “non-transitory” should not be interpreted that the memory 170 is non-movable. In some examples, the memory 170 can be configured to store larger amounts of information than the memory 170. In certain examples, a non-transitory storage medium may store data that can, over time, change (e.g., in random access memory (RAM) or cache).

The TransPlorer engine 120, Network interfaces 150 and Processor 160 may be implemented as at least one hardware processor.

Although FIG. 2 shows the hardware components of the UE 100 but it is to be understood that other embodiments are not limited thereon. In other embodiments, the UE 100 may include less or more number of hardware components. Further, the labels or names of the components are used only for illustrative purpose and does not limit the scope of the disclosure. One or more components can be combined together to perform same or substantially similar function for performing the data communication in the wireless network system 1000b.

FIG. 3 is a schematic diagram illustrating a wireless network system for providing the content to the UE from the content server, according to an embodiment of the disclosure.

In an embodiment, the wireless network system 1000b includes the UE 100, the at least one DNS server 200a-200c and a CDN 300, where the CDN 300 includes the at least one content server 300a-300d. The DNS lookup API 111 of the application 110 sends the request for content to the DNS explorer 121 of the TransPlorer engine 120 when the application 110 needs to download or receive the content. The DNS explorer 121 sends the DNS query to the at least one DNS server 200a-200c, in response to receiving the request for the content from the application 110. The at least one DNS server 200a-200c provides the DNS messages including the IP address of the at least one content server 300a-300d to the DNS explorer 121. Further, the DNS explorer 121 provides the request for the content and the DNS messages to the path navigator 122. The path navigator 122 establishes the connections with the plurality of socket descriptors 122a-122d simultaneously or in consecutive order to the at least one content server 300a-300d through the network paths available at the network interfaces 150 based on the IP address. Further, the socket API 112 provides the socket descriptor 113 of the application 110 to the path navigator 122. The path navigator 122 maps the socket descriptor 113 to the plurality of socket descriptor 122a-122d by determining the RTT of each of the connections. Further, the path navigator 122 identifies that the network path connects the UE 100 to the content server 300b has the lowest RTT. Therefore, the path navigator 122 determines that network path that connects the UE 100 and the content server 300b as the optimal network path. Further, the path navigator 122 determines the content server 300b as optimal content server. The path navigator 122 routs or transmits the request for the content to the optimal content server 300b through the socket descriptor 122c, in response to determining that the connection corresponding to the optimal content server 300b has the lower RTT than the RTT of the other connections.

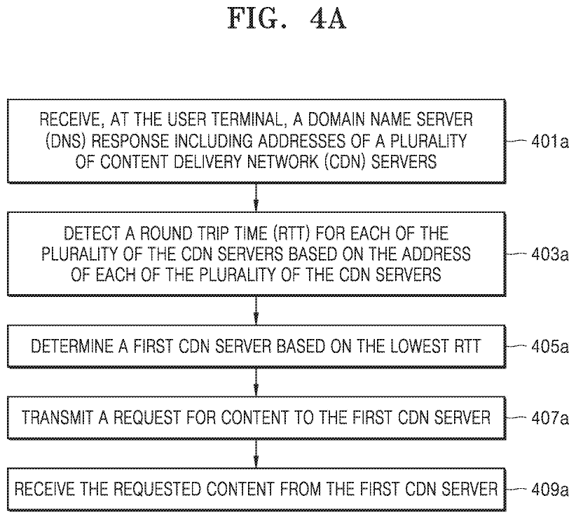

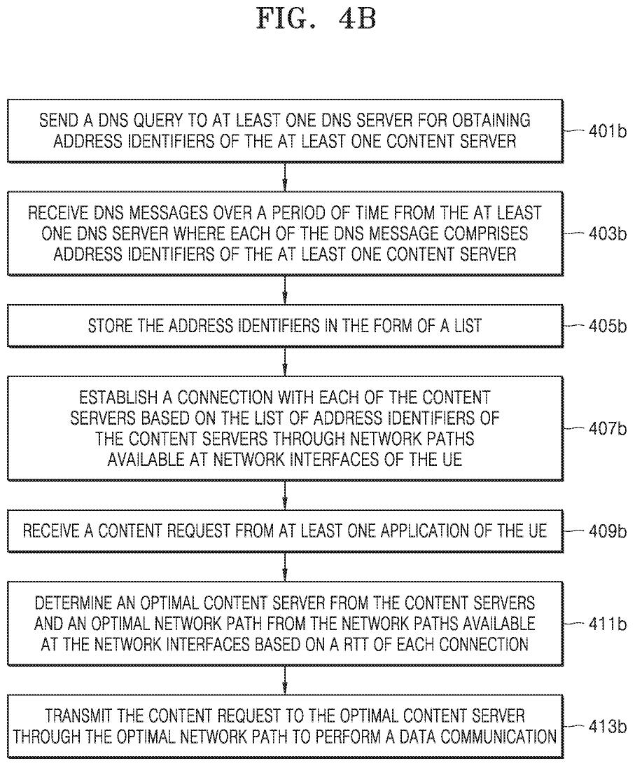

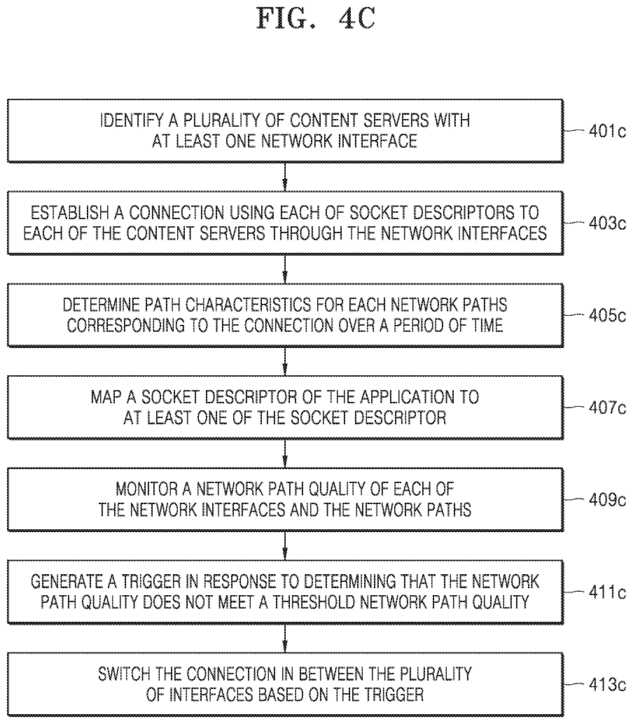

FIG. 4A is a flowchart for establishing a connection between a user terminal and a content server, according to an embodiment of the disclosure.

The user terminal may be the UE 100. At operation 401a, the user terminal may receive a DNS response which is in response to a request for addresses of the plurality of the CDN servers. Thus, the DNS response may include addresses of a plurality of CDN servers. The user terminal may select a DNS to transmit the request for the addresses of the plurality of the CDN servers based on location information of the user terminal. That is, the user terminal may select a CDN server which is located close to the user terminal based on GPS information. The user terminal may store the addresses of the plurality of CDN servers in a content cache of a memory 170.

At operation 403a, the user terminal may detect a round trip time (RTT) for each of the plurality of the CDN servers based on the address of each of the plurality of the CDN server. The RTT is a time length for rounding trip of a signal from the user terminal (signal sender) via one of the CDN servers (signal receiver) to the user terminal again.

At operation 405a, the user terminal may determine one CDN server with which the RTT is the lowest among the CDN servers.

At operation 407a, the user terminal may transmit a request for content to the determined CDN server. At operation 409a, the user terminal may receive the requested content from the first CDN server.

The various actions, acts, blocks, operations, or the like in the flowchart illustrated referring to FIG. 4A may be performed in the order presented, in a different order or simultaneously. Further, in some embodiments, some of the actions, acts, blocks, operations, or the like may be omitted, added, modified, skipped, or the like without departing from the scope of the disclosure.

FIG. 4B is a flowchart illustrating a method for establishing a connection between a user terminal and the content server, according to an embodiment of the disclosure.

At operation 401b, the DNS explorer 121 may sends a DNS query to at least one DNS server 200a-200c in the wireless network system for obtaining address identifiers of the at least one content server 300a-300d. At operation 403b, the DNS explorer 121 may receive a DNS messages over a period of time from the at least one DNS server 200a-200c in the wireless network system, where each of the DNS message includes the address identifiers of the at least one content server 300a-300d. At operation 405b, the UE 100 may store the address identifiers in the form of a list in the memory 170.

At operation 407b, the UE 100 may establish a connection with each of the content servers 300a-300d based on the list of address identifiers of the content servers 300a-300d through the network paths available at the network interfaces 150 of the UE 100. In an embodiment, the path navigator 122 may establish the connection with each of the content servers 300a-300d. At operation 409b, the DNS explorer 121 may receive the content request from the at least one application 110 of the UE 100. At operation 411b, the path navigator 122 may determine the optimal content server 300b from the content servers 300a-300d and the optimal network path from the network paths available at the network interfaces 150 based on the RTT of each connection. At operation 413b, the path navigator 122 may transmit or route the content request to the optimal content server 300b through the optimal network path to perform the data communication.

The various actions, acts, blocks, operations, or the like in the flowchart illustrated referring to FIG. 4B may be performed in the order presented, in a different order or simultaneously. Further, in some embodiments, some of the actions, acts, blocks, operations, or the like may be omitted, added, modified, skipped, or the like without departing from the scope of the disclosure.

FIG. 4C is a flowchart illustrating a method of switching the connection, according to an embodiment of the disclosure.

At operation 401c, the UE 100 may identify a plurality of content servers 300a-300d with the at least one network interface 150. At operation 403c, the path navigator 122 may establish the connection using each of the socket descriptors 122a-122h to each of the content servers 300a-300d through the network interfaces 150.

At operation 405c, the path navigator 122 may determine the path characteristics for each network path corresponds to the connection over the period of time. At operation 407c, the path navigator 122 may map the socket descriptor 113 of the application 110 to at least one of the socket descriptor 122a-122h. At operation 409c, the path navigator 122 may monitor the network path quality of each of the network interfaces 150 and the network paths.

At operation 411c, the path navigator 122 may generate the trigger in response to determining that the network path quality does not meet a predetermined value—the threshold network path quality. At operation 413c, the method includes switching the connection in between the plurality of interfaces 150 based on the trigger. In an embodiment, the method allows the path navigator 122 to switch the connection between the plurality of interfaces 150 based on the trigger.

The various actions, acts, blocks, operations, or the like in the flowchart referring to FIG. 4C may be performed in the order presented, in a different order or simultaneously. Further, in some embodiments, some of the actions, acts, blocks, operations, or the like may be omitted, added, modified, skipped, or the like without departing from the scope of the disclosure.

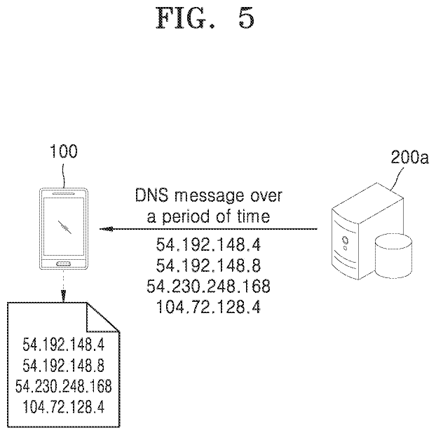

FIG. 5 illustrates an example scenario in which the UE receives DNS messages from a DNS server, according to an embodiment of the disclosure.

Referring to FIG. 5, the Wi-Fi DNS server 200a may be only available for the UE 100 to obtain the DNS messages. The Wi-Fi DNS server 200a provides the DNS messages at different time in a day to the UE 100, in response to receiving the DNS request from the UE 100. Each of the DNS messages may include IP address of different content servers 300a-300d. Therefore, the UE 100 stores the DNS message over the period of time (e.g. 1 millisecond (ms)), in response to receiving the DNS message from the Wi-Fi DNS server 200a.

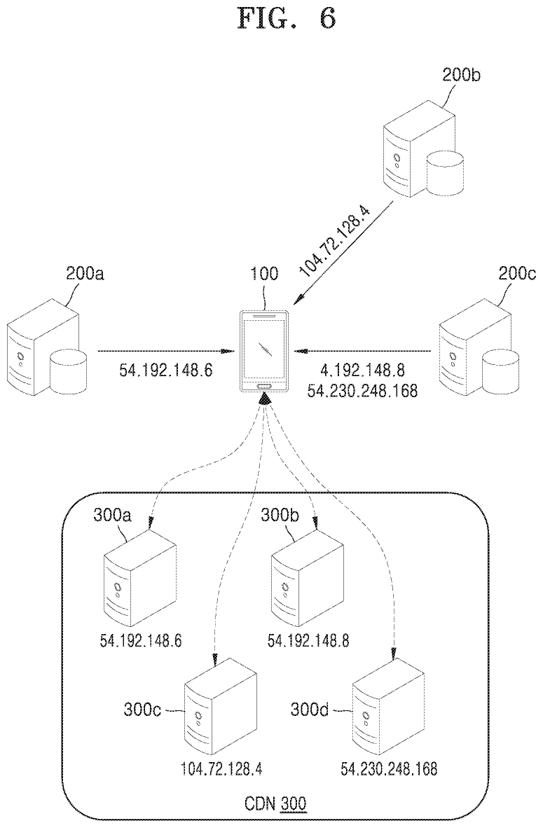

FIG. 6 illustrates an example scenario in which the UE receives the DNS messages from DNS servers, according to an embodiment of the disclosure.

Referring to FIG. 6, the DNS servers 200a-200c may be available for the UE 100 to receive the DNS messages. The DNS servers 200a-200c provide the DNS messages to the UE 100, in response to receiving the DNS query from the UE 100. The Wi-Fi DNS server 200a provides the IP address of a default content server 300a to the UE 100. The cellular operator DNS server 200b provides the IP address of a default content server 300c to the UE 100. Further, the public DNS server 200c provides the IP address of the content server 300b and the IP address of the content server 300d to the UE 100. Therefore, the UE 100 uses all the received IP addresses to establish connections with the content severs 300a-300d simultaneously or in a consecutive order through the Wi-Fi network interface 150b and the cellular network interface 150a.

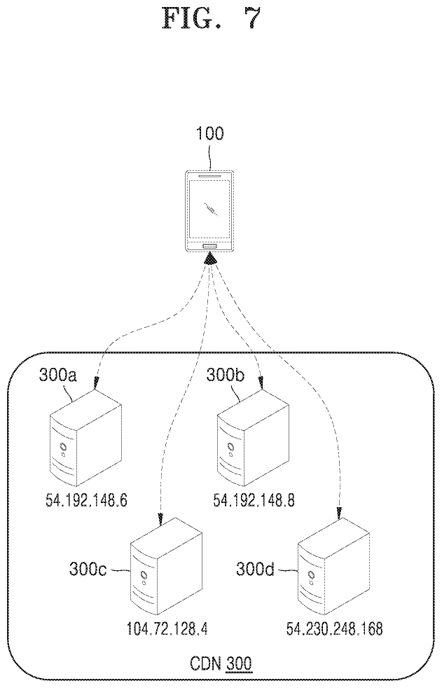

FIG. 7 illustrates an example scenario in which the UE determines the optimal network path for a network interface for accessing content, according to an embodiment of the disclosure.

Referring to FIG. 7, the UE 100 stores the DNS messages including the IP address of the content servers 300a-300d, where the IP address of the content servers 300a-300d are 54.192.148.6, 54.192.148.8, 104.72.128.4 and 54.230.248.168, respectively. The UE 100 establishes the connection with the content severs 300a-300d simultaneously or in a consecutive order through the Wi-Fi network interface 150b and the cellular network interface 150a using the IP address. Further, the UE 100 determines the RTT of each connections of the UE. The UE 100 determines the RTT of each connection as given in Table 1 (RTT of each network path).

TABLE 1

| | | RTT of connection |
|---|---|---|
| | RTT of connection | enabled through 4G- |
| | enabled through Wi-Fi | LTE cellular network |
| IP address | network interface | interface |
| 54.192.148.6 | 100 ms | 90 ms |
| 54.192.148.8 | 90 ms | 50 ms |
| 104.72.128.4 | 140 ms | 65 ms |
| 54.230.248.168 | 130 ms | 40 ms |

The UE 100 determines that the connection to the IP address 54.192.148.8 has the lowest RTT among the connections, when the UE 100 establishes the connection through the Wi-Fi network interface 150b. Therefore, the UE 100 determines the network path with the IP address 54.192.148.8 as the optimal network path for performing the data communication through the Wi-Fi network interface 150b. The UE 100 determines that the connection to the IP address 54.230.248.168 has the lowest RTT among connections, when the UE 100 establishes the connection through the 4G-LTE cellular network interface 150a. Therefore, the UE 100 determines the network path with the IP address 54.230.248.168 as optimal network path for performing the data communication through the 4G-LTE cellular network interface 150a.

FIG. 8 illustrates an example scenario in which the UE switches seamlessly from a connection to a content server to a connection to another content server using a socket descriptor, according to an embodiment of the disclosure.

Referring to FIG. 8, the UE 100 stores the DNS messages including the IP address of the content servers 300a-300d, where the IP address of the content servers 300a-300d are 54.192.148.6, 54.192.148.8, 104.72.128.4 and 54.230.248.168, respectively. The UE 100 includes the plurality of the socket descriptor 122a-122h and the application socket descriptor 113. The UE 100 is able to access the CDN 300 either through a Wi-Fi network 400 or through a cellular network 500.

Referring to FIG. 8, the UE 100 receives the content request from the application 110 to receive or download the content. The UE 100 establishes 801 the connection with the content severs 300a-300d simultaneously or in a consecutive order through the Wi-Fi network interface 150b using each of the socket descriptor 122a-122d based on the IP address. The UE 100 also establishes the connection with the content severs 300a-300d simultaneously through the 4G-LTE cellular network interface 150a using each of the socket descriptor 122e-122f based on the IP address. Further, the UE 100 maps 802 the socket descriptor 113 of the application 110 to the plurality of socket descriptors 122a-122d connected through the Wi-Fi network interface 150b by determining the RTT of each of the connections established through the Wi-Fi network interface 150b.

Further, the UE 100 maps 803 the socket descriptor 113 of the application 110 to the plurality of socket descriptors 122e-122h connected through the 4G-LTE cellular network interface 150a by determining the RTT of each of the connections established through the 4G-LTE cellular network interface 150a. The UE 100 determines 804 the network path with IP address 54.192.148.8 connected through the Wi-Fi network interface 150b with the socket descriptor 122c as the optimal network path based on the lower RTT of the connection. Therefore, the UE 100 determines the content server 300b as the optimal content server and routes or transmits the content request to the content server 300b through the Wi-Fi network interface 150b with the socket descriptor 122c for accessing the content.

Let's assume that the signal strength of the Wi-Fi network 400 become weaker 805. Therefore, the UE 100 detects 806 that the signal strength of the 4G-LTE cellular network 500 is stronger than the signal strength of the Wi-Fi network 400. The UE 100 maps the socket descriptor 113 of the application 110 to the plurality of socket descriptor 122a-122d connected through the Wi-Fi network interface 150b by determining the RTT of each of the connections established through the Wi-Fi network interface 150b. Further, the UE 100 maps the socket descriptor 113 of the application 110 to the plurality of socket descriptor 122e-122h connected through the 4G-LTE cellular network interface 150a by determining the RTT of each of the connections established through the 4G-LTE cellular network interface 150a. Further, the UE 100 determines the network path with IP address 54.230.248.168 connected through the 4G-LTE cellular network interface 150a with the socket descriptor 122e as the optimal network path based on the lower RTT of the connection. Therefore, the UE 100 determines 807 the content server 300d as the optimal content server. Further, the UE 100 seamlessly switches 808 the connection from the Wi-Fi network interface 150b to the 4G-LTE cellular network interface 150a for performing the data communication, where the UE 100 uses the socket descriptor 122e to route the content request to the content server 300d for accessing the content.

A performance of the TCP connection is severely affected by a user perceived delays, when the application 110 establishes a new TCP connection or sends the data of the content over a poor quality network path. The UE 100 identifies the poor quality network path by monitoring the RTT of each TCP connection. When the application 110 tries to establish a new TCP connection over the poor quality network interface, the UE 100 identifies a quality of the network interfaces 150 using other ongoing TCP connections on the same interfaces 150. When the RTT of the TCP connections on one network interface (for example, Wi-Fi network interface 150b) reduces, the UE 100 binds TCP sockets over other network interface (for example, cellular network interface 150a). Further, the UE 100 diverts all the new TCP connections to the network interface, optimal for the data communication. In case of the long lived streaming TCP connections, the UE 100 establishes redundant TCP connections over the multiple network interfaces 150 and dynamically maps the application socket descriptor 113 to the TCP connection having the lowest RTT. Thus, the UE 100 monitors the TCP connections over multiple network interfaces 150 and migrates all the new and established TCP connections to the optimal network interface seamlessly.

Generally, the UE 100 prefers the Wi-Fi network 400 to the 4G-LTE network 500 in connecting to remote content servers, even though edge content servers are available near to the UE 100 with a low latency. The UE 100 may determine all the available content servers 300a-300d via the public DNS server 200c and the 4G-LTE operator DNS server 200b. Further, the UE 100 establishes simultaneous or consecutive connections with the content servers 300a-300d. The UE 100 classifies both the remote content servers and the edge content servers based on the RTT and determines the optimal network path. Thus, the UE 100 identifies the edge content servers and diverts the application 110 to establish the connection over the 4G-LTE network 500.

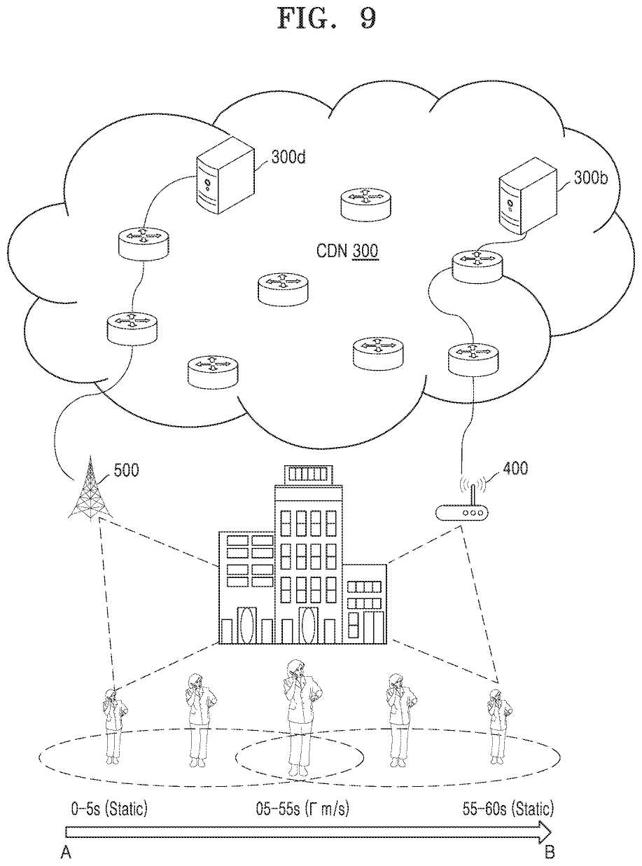

FIG. 9 is a schematic diagram illustrating an experimental setup for evaluating the TransPlorer method, according to an embodiment of the disclosure.

fᵢ is a frequency ratio of number of times when the application 110 (for domain name i) without applying the TransPlorer method connects to the content server 300a-300d with minimum RTT. Pᵢ is a probability that the default content server is the optimal content server for the domain name i. For large enough number of trials nᵢ, let fᵢ=Pᵢ and then Pᵢ is given as Equation 1.

Pi=fi=(Xi/ni) Equation 1

where, Xᵢ is a random variable defined as the number of trials in which the default content server is the optimal content server for the domain i. Since all the trials are independent of each other, X follows a Binomial distribution. Therefore, Xᵢ is given as Equation 2.

Xi˜B(ni,Pi) Equation 2

The probability based on the TransPlorer method benefiting the application 110 kᵢ times out of nᵢ trials for the given domain name i is given as Equation 3.

$$\begin{matrix}( 3 ) & \\ Pr ( {X}_{i} = {n}_{i} - {k}_{i} ) = ( \begin{matrix}{n}_{i} \\ {n}_{i} - {k}_{i}\end{matrix} ) {{p}_{i}^{{n}_{i} - {k}_{i}} ( 1 - {p}_{i} )}^{{k}_{i}} & Equation 3\end{matrix}$$

Here, Zᵢ is a random variable defined as the frequency ratio of a domain name (i.e. Zᵢ=fᵢ).

Zi=Xi/ni Equation 4

Since, Xᵢ follows the Binomial distribution, Xᵢ (and consequently Zᵢ) can be approximate to a Normal distribution using a central limit theorem. Consider a set of D random domain names. Assuming their Xᵢs to be identically distributed and taking equal number of trials (i.e. n=nᵢ ∀i), then Zᵢs ∀i ∈ (1, D) are identically distributed to a random variable Z which is normally distributed.

Z˜N(μN(i²) Equation 5

where, N is a normal distribution with mean μ and variance σ².

An improvement achieved by using the TransPlorer method is quantified for the application 110 using a parameter, RTT ratio γ_{j,i}. The RTT ratio γ_{j,i} is defined for j^{th} trial for the given domain i, as the ratio between the latency or the RTT of the optimal content server and the default content server is given in Equation 6.

$$\begin{matrix}( 6 ) & \\ {Y}_{j , i} = \frac{{RTT}_{best}^{j , i}}{{RTT}_{default}^{j , i}} & Equation 6\end{matrix}$$

where, RTT_{best}^{j,i} is the RTT of the optimal content server in the j^{th} trial for the domain i. RTT_{default}^{j,i} is the RTT of the default content server in the j^{th} trial for the domain i.

An average percentage gain of the RTT for the domain name i is given in Equation 7.

$$\begin{matrix}( 7 ) & \\ {δ}_{avg}^{i} = \frac{1}{{N}_{i}} {\sum }_{j = 1}^{{N}_{i}} ( \frac{1}{{Y}_{j , i}} - 1 ) \times 100 \% & Equation 7\end{matrix}$$

The average percentage gain of the RTT over all the domain names for the application (110) is given in Equation 8.

$$\begin{matrix}( 8 ) & \\ {Δ}_{RTT}^{avg} = \frac{1}{D} {\sum }_{i = 1}^{D} {δ}_{avg}^{i} & Equation 8\end{matrix}$$

Although the latency is a crucial metric for the short lived connections, whereas for the long lived connections a throughput measurement is of more significant. The throughput can be determined using the existing methods, as given in Equation 9.

throughput ∝1/RTT Equation 9

Therefore, the corresponding throughput ratio τᵢ is given in Equation 10.

$$\begin{matrix}( 10 ) & \\ {τ}_{j , i} = \frac{1}{{Y}_{j , i}} & Equation 10\end{matrix}$$

The average percentage gain in throughput/good-put for the application (110) over a set of D domain names is given in Equation 11.

$$\begin{matrix}( 11 ) & \\ {Δ}_{tp}^{avg} = \frac{1}{D} {\sum }_{i = 1}^{D} [ \frac{1}{{N}_{i}} {\sum }_{j = 1}^{{N}_{i}} ( {τ}_{j , i} - 1 ) ] \times 100 \% & Equation 11\end{matrix}$$

The wireless communication system (1000b) is successfully prototyped in the ns-3 simulator for conducting experiments to evaluate the performance of the UE 100. The simulation deploys with the content server 300b and the content server 300d, where both the content servers 300b and 300d contain same content. The content server 300d is close to the 5G mmWave network 500. The content server 300b is close to the Wi-Fi back-haul network 400. For evaluation, three UEs are used simultaneously where first UE (i.e. UE1) is using the TransPlorer method and the other two UEs (i.e. UE2 and UE3) are configured to use different method other than the TransPlorer method. In the scenario, the UE1 is configured to connect with both the 5G mmWave network 500 and the Wi-Fi network 400. The UE2 is always latched with the 5G mmWave network 500 and UE3 is always connected to the Wi-Fi network 400.

Referring to FIG. 9, the UE1, the UE2 and the UE3 move from a point-A to a point-B at 1.5 m/sec and a building is deployed 30 meters away from the user mobility path between the point-A and the point-B. The point-A is close to the 5G mmWave network 500, whereas the point-B is close to the Wi-Fi back-haul 400. As shown in FIG. 9, the UE2 and the UE3 are always connected to the content server 300d and the content server 300b respectively and hence does not perform as the optimal content server in all conditions during the mobility. The UE1 migrates the TCP connections between the content server 300d and the content server 300b, so that the TransPlorer method guarantees an optimal performance irrespective of the network conditions.

The embodiments disclosed herein can be implemented using at least one software program running on at least one hardware device and performing network management functions to control the elements.

While the disclosure has been shown and described with reference to various embodiments thereof, it will be understood by those skilled in the art that various changes in form and details may be made therein without departing from the spirit and scope of the of the disclosure as defined by the appended claims and their equivalents.

What is claimed is:

1. A method of establishing a connection between a user terminal and a content server, the method comprising:
receiving, at the user terminal, a domain name server (DNS) response including addresses of a plurality of content delivery network (CDN) servers;
detecting a round trip time (RTT) for each of the plurality of the CDN servers based on the address of each of the plurality of the CDN servers, the RTT being a time length for rounding trip from the user terminal via one of the CDN servers to the user terminal;
determining a first CDN server based on the lowest RTT;
transmitting a request for content to the first CDN server; and
receiving the requested content from the first CDN server.

2. The method of claim 1, further comprising:
transmitting, to DNS, a request for the addresses of the plurality of the CDN servers,
wherein the DNS response is received in response to the request for the addresses of the plurality of the CDN servers.

3. The method of claim 2, further comprising:
selecting the DNS for the request of the addresses of the plurality of the CDN servers, based on location information of the user terminal.

4. The method of claim 1, further comprising:
storing the addresses of the plurality of CDN servers in a first content cache of the user terminal.

5. The method of claim 1, further comprising:
establishing a connection to the first CDN server to transmit the request for the content,
wherein the connection is established by connecting to the first CDN server with a socket descriptor of the user terminal.

6. The method of claim 1, further comprising:
determining path characteristics for each network path between the user terminal and each of the plurality of the CDN servers,
wherein the path characteristics comprise at least one of a behavior of applications installed in the user terminal, the number of connections per domain, or the number of application request forwarded to each of the plurality of the CDN servers.

7. The method of claim 1, wherein the transmitting of the request for the content to the first CDN server comprises routing the request for the content to the first CDN server by mapping a socket descriptor of an application requesting the content to a socket descriptor of the first CDN server.

8. The method of claim 1, further comprising:
monitoring a network path quality between the user terminal and the first CDN server;
determining whether the network path quality meets a predetermined value; and
switching a connection to a second CDN server based on the network path quality.

9. The method of claim 8, wherein the determining of whether the network path quality meets the predetermined value comprises:
determining the network path quality based on at least one of a user mobility, a signal strength fluctuation, a signal to noise ratio, a degree of a congestion in a path of a network, a type of network interface, a packet processing time, or a type of IP which includes IPv4 or IPv6.

10. The method of claim 9, wherein the type of network interface comprises at least one of Wi-Fi network interface or a cellular network interface.

11. The method of claim 1, wherein the detecting of the RTT for each of the plurality of the CDN servers comprises identifying the RTT for each of the plurality of the CDN servers based on at least one of a behavior of application installed in the user terminal, the number of connections per domain, the number of application request forwarded to each of the CDN servers, or a network path quality.

12. An apparatus for establishing a connection with a content server, the apparatus comprising:
a memory; and
at least one processor configured to:
receive a domain name server (DNS) response including addresses of a plurality of content delivery network (CDN) servers,
detect a round trip time (RTT) for each of the plurality of the CDN servers based on the address of each of the plurality of the CDN servers, the RTT being a time length for rounding trip from the apparatus via one of the CDN servers to the apparatus,
determine a first CDN server based on the lowest RTT,
transmit a request for content to the first CDN server, and
receive the requested content from the first CDN server.

13. The apparatus of claim 12,
wherein the at least one processor is further configured to transmit, to a DNS, a request for the addresses of the plurality of the CDN servers, and
wherein the DNS response is received in response to the request for the addresses of the plurality of the CDN servers.

14. The apparatus of claim 13, wherein the at least one processor is further configured to select the DNS for the request of the addresses of the plurality of the CDN servers, based on location information of the apparatus.

15. The apparatus of claim 12, wherein the memory is configured to store the addresses of the plurality of CDN servers in a first content cache.

16. The apparatus of claim 12,
wherein the at least one processor is further configured to establish a connection to the first CDN server to transmit the request for the content, and
wherein the connection is established by connecting to the first CDN server with a socket descriptor of the apparatus.

17. The apparatus of claim 12,
wherein the at least one processor is further configured to determine path characteristics for each network path between the apparatus and each of the plurality of the CDN servers, and
wherein the path characteristics comprise at least one of a behavior of applications installed in the apparatus, the number of connections per domain, or the number of application request forwarded to each of the plurality of the CDN servers.

18. The apparatus of claim 12, wherein the at least one processor is further configured to route the request for the content to the first CDN server by mapping a socket descriptor of an application requesting the content to a socket descriptor of the first CDN server.

19. The apparatus of claim 12, wherein the at least one processor is further configured to:
monitor a network path quality between the user terminal and the first CDN server;
determine whether the network path quality meets a predetermined value; and
switch a connection to a second CDN server based on the network path quality.

20. The apparatus of claim 19, wherein the at least one processor is further configured to determine the network path quality based on at least one of a user mobility, a signal strength fluctuation, a signal to noise ratio, a degree of a congestion in a path of a network, a type of network interface, packet processing time, or a type of IP which includes IPv4 or IPv6.
